(19) United States
(12) Patent Application Publication
(10) Pub. No.: US 2007/0080557 A1
(43) Pub. Date: Apr. 12, 2007

(54) Track and trolley system for a cargo portion of a vehicle

(76) Inventors: Andrew M. Knepper, Woodville, OH (US); Kenneth R. Weschke JR., Fostoria, OH (US)

Correspondence Address: MARSHALL & MELHORN, FOUR SEAGATE, EIGHT FLOOR, TOLEDO, OH, 43604, US

(21) Appl. No.: 11/247,311

(22) Filed: Oct. 11, 2005

(51) Int. Cl. B62D 25/06

(52) U.S. Cl. 296/105

(57) ABSTRACT

A track and trolley system for a cargo portion of a vehicle, and a method for using the same, is described. The track comprises a single, outer, upper portion with a substantially convex wheel receiving surface and a single, outer, lower portion with a substantially convex wheel receiving surface that is substantially vertically aligned with said wheel receiving surface of said upper portion. The trolley supports a first upper axle, at least a second upper axle and at least one lower axle. Wheels having concave outer surfaces are rotatingly attached to each of the axles. The concave outer surfaces of the wheels engage with the convex wheel receiving surfaces of the track.

### FIELD OF THE INVENTION

The present invention relates to an apparatus for, and a method of using, a track and trolley system for a cargo portion of vehicle.

### BACKGROUND OF THE INVENTION

Tarping systems for covering the cargo portion of a vehicle are well-known. Typically, such systems comprise a tarp supported over the cargo portion with a plurality of tarp supports. The tarp supports are fixed to trolleys that move along track rails located along the cargo portion.

There are a variety of known track and trolley systems. For example, U.S. Pat. No. 4,711,484 describes a system where each trolley contains at least two upper wheels and at least two lower wheels, where both sets of wheels ride within a track attached to a cargo portion of a vehicle. The individual trolleys of the system are designed to overlap at least partially within one another when the tarp supports are in the collapsed condition. It is alleged that by overlapping the trolleys, a larger portion of the cargo portion can be opened up for loading and unloading cargo. This is, however, at the cost of requiring a wider track to accommodate the overlapped trolleys. Those skilled in the art will appreciate that adding additional width to the cargo portion may make the vehicle trailer too wide to meet road regulations or undesirably require that the cargo portion itself be narrower so that the trailer is not too wide for the road.

U.S. Pat. No. 4,902,064, having a common inventor with U.S. Pat. No. 4,711,484, teaches a similar track and trolley system wherein the trolleys roll along an internal portion of the track. This design suffers from the same disadvantage as the patent discussed above in that additional width is required to accommodate two sets of tandem upper wheels placed side-by-side and two sets of tandem lower wheels placed side-by-side on the internal portion of the track.

U.S. Pat. No. 5,538,313 teaches a trolley system having tandem wheels designed to ride along the inside portion of a track. A cam device is included on the trolley system to tension a tarp carried by tarp supports attached to the trolley system. Because of the cam device, the system suffers from unnecessary complexity and, because the wheels ride on the inside of the track, it undesirably adds width to the cargo portion of the trailer.

U.S. Pat. No. 5,924,759 depicts and describes a trolley system having two large, vertically oriented wheels, two smaller, vertically oriented wheels and two horizontally oriented wheels. The two large vertically oriented wheels ride along the outer, upper portion of the track while the two smaller, vertically oriented wheels ride along the inner, lower portion of the same track. The horizontally oriented wheels ride along the side of the truck bed. According to the patent, these six wheels are required to limit lateral movement of the trolley. Those skilled in the art will appreciate, however, that the invention is unnecessarily complex and the additional components undesirably add to the cost of the trolley.

Finally, U.S. Pat. No. 6,065,796 teaches yet another trolley system comprised of at least two vertically oriented wheels and at least two horizontally oriented wheels. The patent alleges that the two sets of wheels are required to maintain lateral stability of the trolley. The additional wheels, though, disadvantageously add cost, complexity and materials to the trolley.

In light of the disadvantages of the prior art briefly discussed above, it would be advantageous to reduce or prevent lateral motion of the trolleys and of the tarp supports in a cost effective, simple and low cost manner. It would also be advantageous for a trolley to be as thin as possible to avoid extending the cargo portion beyond permissible limits or to avoid removing valuable area from the cargo portion to accommodate the track and trolleys.

### SUMMARY OF THE INVENTION

The present invention is directed toward a track and trolley system for a cargo portion of a vehicle, and a method for using the same. The system comprises a track secured to the cargo portion of the vehicle. The track has a single, outer, upper portion with a substantially convex wheel receiving surface and a single, outer, lower portion with a substantially convex wheel receiving surface. The lower wheel receiving surface is substantially vertically aligned with the wheel receiving surface of the upper portion.

The trolley comprises a support plate with a first upper tandem axle, at least a second upper tandem axle and at least one lower axle. A wheel is rotatingly attached each of the first upper tandem axle, the second upper tandem and the lower axle. Each of the wheels has a concave outer surface for engaging with the convex wheel receiving surfaces of the track. Preferably, the wheels on the upper tandem axles and the wheel on the lower axle bound the track between them.

The invention also preferably comprises a gasket securing portion attached to the track for securing a first end of a gasket therein. The gasket extends substantially horizontally so that a second end of the gasket contacts the support plate.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic, perspective view of the invention located on an exemplary embodiment of a vehicle;

FIG. 2 is a schematic, rear view of a component of the present invention;

FIG. 2A is a schematic, rear view of an alternative embodiment of the structure shown in FIG. 2;

FIG. 3 is a schematic, side view of the component of the present invention from FIG. 2; and

FIG. 4 is a side view depicting an alternative embodiment of the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

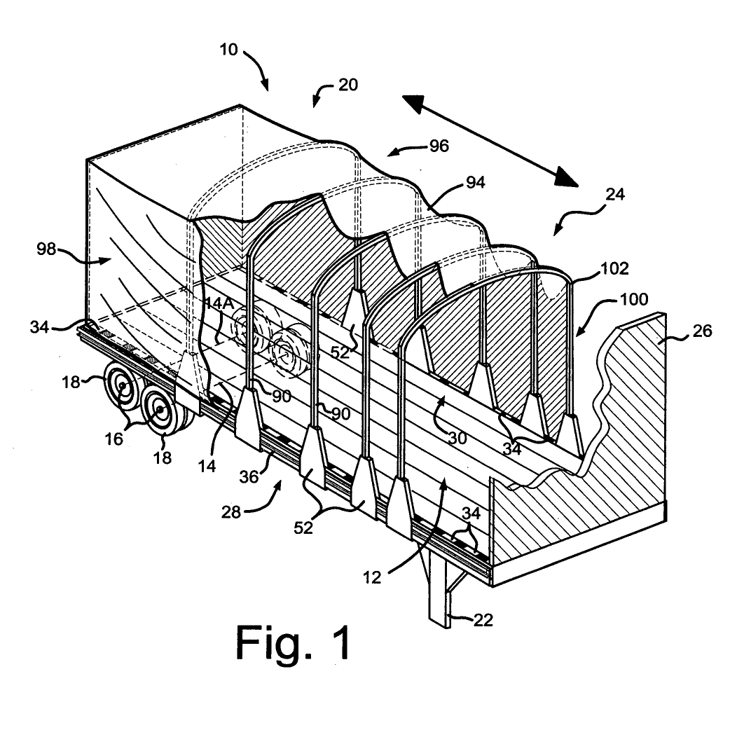

Referring now to FIG. 1, a schematic, perspective view of the invention located on an exemplary embodiment of a vehicle is depicted. Those skilled in the art will appreciate the vehicle of FIG. 1 is a semi-trailer 10 typically pulled by a tractor (not shown). The present invention, however, is not limited to only semi-trailer vehicles. Instead, the present invention may be utilized with any vehicle having a cargo carrying portion 12. By way of example only, the present invention may be used with full trailers, multi-level trailers, such as drop deck trailers and double drop deck trailers, dump trucks, pickup trucks, or any other similar vehicles known to those skilled in the art.

As shown in FIG. 1, the semi-trailer 10 has mounted thereto at least one axle 14. At least one wheel 16 is mounted on each end of the axle 14 and at least one tire 18 is mounted on each wheel 16. The semi-trailer 10 of FIG. 1 depicts two axles 14, 14a adjacent a rear portion 20 of the semi-trailer 10, however, the present invention may be used with any trailer having any number of axles located anywhere on the trailer. Typically, a landing gear 22 is located at a forward portion 24 of the trailer 10 to support the trailer 10 when it is not connected to a tractor.

A forward panel 26 is shown attached to the forward portion 24 of the trailer 10. The forward panel 26 may be of any height, width or shape and it may be constructed out of any material. By way of example only, FIG. 1 depicts the forward panel 26 as substantially rectangular and substantially extending from a first side 28 of the trailer 10 to a second side 30 of the trailer 10. The panel 26 may be constructed of stainless steel, or any other metal or another material such as plastic, wood, and/or a tarpaulin-type material over a frame secured to the trailer 10.

The rear portion 20 of the trailer 10 may be selectively opened and closed via a hinged door or two hinged doors (neither of which is shown) mounted on a frame (not shown) secured to the trailer 10. Other doors, such as roll-away type doors (not shown) are also within the scope of the present invention. It is also within the scope of the present invention for the rear portion 20 of the trailer 10 to have a fixed, rear panel, similar or identical to the forward panel 26 described above and depicted in FIG. 1. The door, or doors, would substantially close the rear portion 20 of the trailer 10 on a selective basis. The type of door, or rear panel, used, however, is not critical to the present invention.

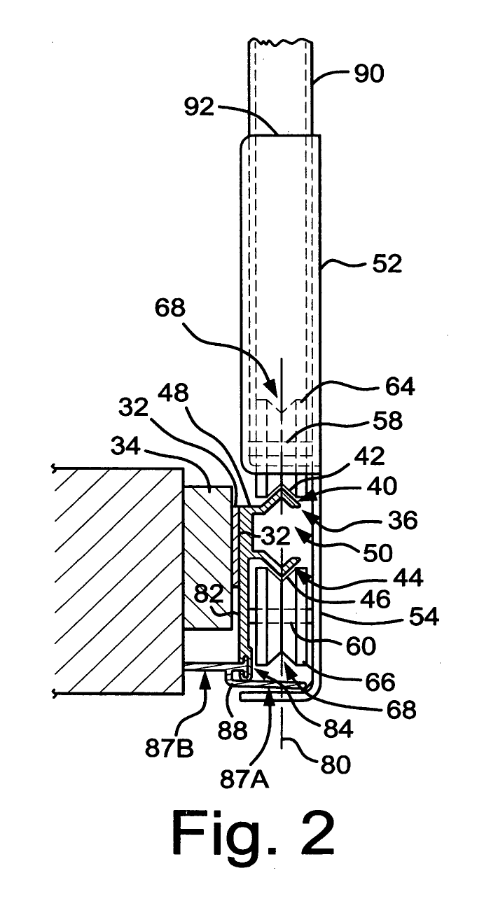

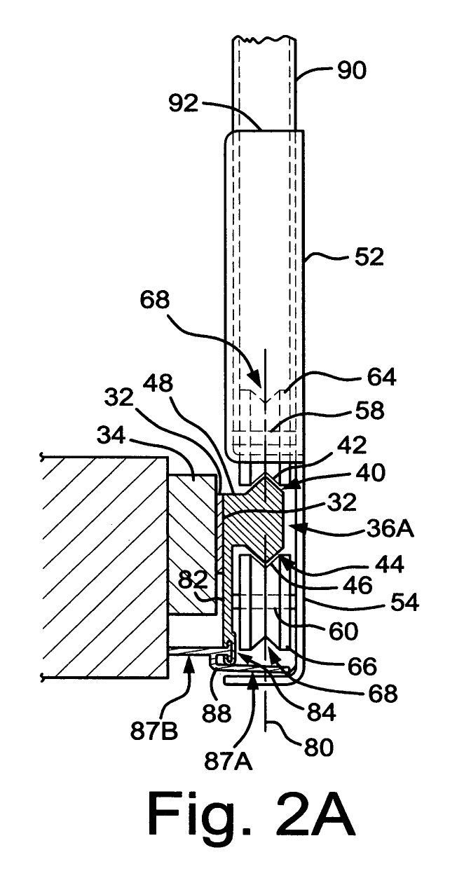

As best seen in FIG. 2, a first rub rail 32 is secured to the first side 28 of the trailer 10. A second rub rail (not shown in FIG. 2) is also secured to the second side 30 of the trailer 10. The size, shape and length of the rub rails 32 is not critical to the present invention, although it is preferred that the rub rails 32 extend substantially along the length of the trailer 10.

A plurality of stake pockets 34 may be located between the rub rail 32 and the cargo portion 12 for receiving one or more stakes (not shown). Once located in the stake pockets 34, the stakes extend substantially vertically from the pockets 34 and the cargo portion 12. Stakes are frequently used in trailers 10 to prevent cargo from shifting or leaving the trailer 10 during transport. The stakes may be used by themselves and/or in combination with other horizontal supports to prevent cargo from shifting or leaving the trailer 10.

As shown in FIG. 2, a track 36 is secured to an outer surface 38 of the rub rail 32. An identical track is secured to the rub rail on the other side of the cargo portion 12. For purposes of clarity and conciseness, one track and the components riding along that track are described below and depicted in the Figures. It should be appreciated that identical, or substantially similar, structures are located on the other side of the cargo portion 12 of the vehicle 10.

The track 36 is substantially continuous and extends from the forward portion 24 of the cargo portion 12 to the rear portion 20 of the cargo portion 12 on both the first side 28 and the second side 30. As used above, the word continuous is meant to mean a track 36 extending substantially from the forward portion 24 of the cargo portion 12 to the rear portion 20 of the cargo portion 12, whether that be via a single, monolithic track 36 or a plurality of tracks 36 located together end-to-end.

Of course, it can be appreciated that if a multi-level trailer is used, the track 36 may comprise at least one upper level (not shown) and at least one lower level (not shown) which together may extend from the forward portion 24 of the cargo portion 12 to the rear portion 20 of the cargo portion. Naturally, some trailers, such multi-level trailers, do not require the track and trolley system described herein to extend along the entire length of the trailer. It must be understood, however, that the present invention may be used with any portion of a vehicle and it is in no way limited to applications for the entire length of a trailer.

The track 36 is preferably comprised of a single, outer, upper portion 40 with a substantially convex wheel receiving surface 42 and a single, outer, lower portion 44 with a substantially convex wheel receiving surface 46. Exemplary shapes of the meaning of convex wheel receiving surfaces 42, 46 considered within the scope of the present invention include, but are not limited to, V-shaped and U-shaped.

As used above, the term outer is meant to mean the wheel receiving surfaces 42, 46 are located on the outside of the track 36 as opposed to the inside of the track 36 or within the track 36 itself.

As best seen in FIG. 2, it is preferred that the wheel receiving surface 42 of the upper portion 40 and the wheel receiving surface 46 of the lower portion 44 of the track 36 are substantially vertically aligned with one another.

It is also preferred that the upper portion 40 and the lower portion 44 of the track 36 are constructed from a metal material, such as an aluminum alloy. Other metals, as well as other materials, such as polymers like plastic and nylon and/or wood, may be used with the present invention without departing from the scope of the present invention. Regardless of the material used, it is preferred that the upper portion 40 and the lower portion 44 be integrally formed with a support rail 48. The support rail 48 is secured to the rub rail 32, the stake pockets 34 and/or the trailer 10 with a plurality of mechanical fasteners, clips, male/female couplings and/or by welding.

FIG. 2 also depicts a substantially continuous channel 50 located between the single, outer, upper portion 40 and the single, outer lower portion 44 of the track 36. While a substantially continuous channel 50 is depicted in the figure, it should be appreciated that the channel 50 may be divided by any number of plates or supports without departing from the present invention.

The channel 50 depicted in FIG. 2 is approximately C-shaped. The present invention is not limited to C-shaped channels and may include, by way of example only, a channel which is closed on all sides.

An alternative embodiment of the track is depicted in FIG. 2A. In FIG. 2A, it can be seen that the track 36A is substantially solid. One or more lightening holes (not shown) may be located in the solid track 36A to reduce the weight of the track 36A if desired. It can be appreciated that the solid track 36A is more damage resistant than the hollow track 36 depicted in FIG. 2 It can also be appreciated that the track 36A depicted in FIG. 2A may be thinner than the track 36 depicted in FIG. 2 due to the solid construction of the track 36A, thus saving space. The track 36A may be attached to the trailer 10 as the track 36 is attached to the trailer 10 disclosed above.

The invention also comprises a trolley 52 having a support plate 54 with a first upper axle 56 and at least a second upper axle 58. The first upper axle 56 and the second upper axle 58 are in tandem with one another. At least one lower axle 60 is also mounted to the support plate 54. The support plate 54 is located outwardly from the track 36. The above-mentioned axles 56, 58, 60 extend inwardly from the support plate 54 toward the track 36.

At least one wheel is rotatingly mounted on each of the first upper axle 56, the second upper axle 58 and the lower axle 60, reference numbers 62, 64 and 66, respectively. As best seen in FIG. 2, it is preferable that each of the wheels 62, 64, 66 has a concave outer surface 68. The concave outer surfaces 68 of the wheels 62, 64, 66 are designed to be complementary to the convex wheel receiving surfaces 42, 46 of the upper and lower portions 40, 44. Exemplary shapes of the meaning of concave outer surfaces 68 considered within the scope of the present invention include, but are not limited to, V-shaped and U-shaped.

While it is preferred that the wheels 62, 64, 66 have concave outer surfaces 68 and the track 36 has convex wheel receiving surfaces 42, 46, it is within the scope of the present invention to switch these so that the track 36 has a concave wheel receiving surface and the wheels 62, 64, 66 have convex outer surfaces. It is also within the scope of the present invention for the upper portion 40 of the track 36 to have a convex wheel receiving surface 42 and the upper wheels 62, 64 to have concave outer surfaces 68 and for the lower portion 46 of the track 36 to have a concave wheel receiving surface and for the lower wheel 66 to have convex outer surfaces and vice versa.

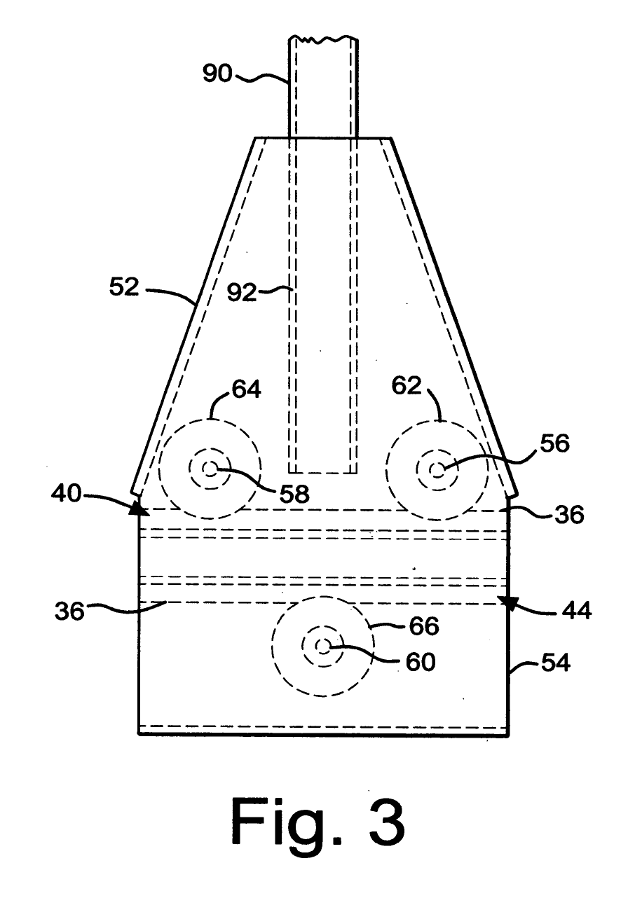

As seen in FIG. 3, the lower axle 60 and its associated wheel 66 are positioned below and substantially midway between the tandem upper axles 56, 58 and their associated wheels 62, 64. While this is a preferred orientation of the axles 56, 58, 60, it should be appreciated that other orientations, such as the lower axle 60 being located closer to one of the upper axles 56 or 58 than the other one, are within the scope of the present invention.

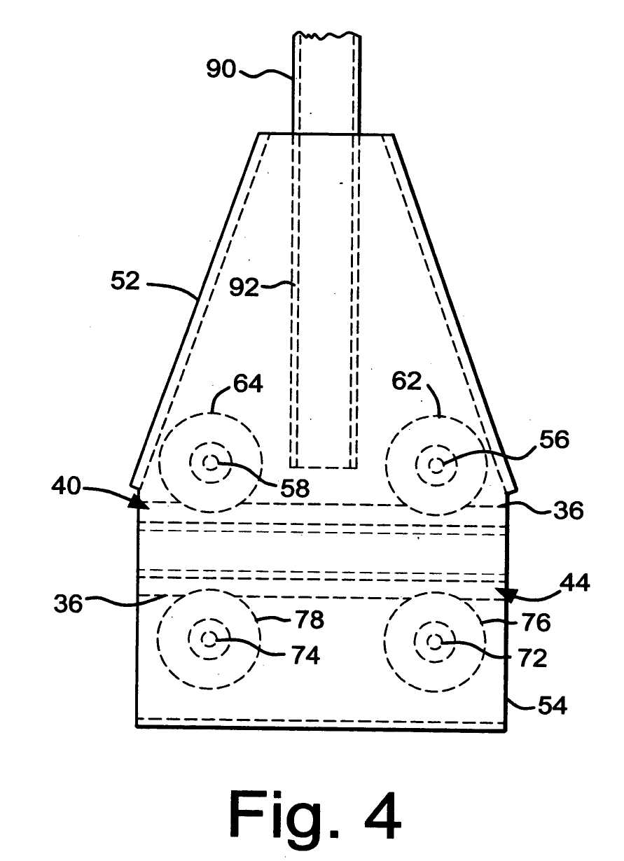

By way of example only, another embodiment of the present invention is depicted in FIG. 4 wherein the tandem upper wheels 62, 64 described above are utilized and tandem lower wheels 70, 72 replace the single lower wheel 66 described above and depicted in FIG. 3.

Looking now at FIG. 4, two lower axles are mounted to the support plate 54. Preferably, a first lower axle 72 is substantially aligned with one of the upper axles 56 and a second lower axle 74 is substantially aligned with the other upper axle 58. While the preferred embodiment depicted in FIG. 4 shows the upper and lower axles 56, 58, 72, 74 aligned with one another, it is within the scope of the present invention for the lower axles 72, 74 not to be aligned with the upper axles 56, 58.

A first lower wheel 76 is mounted for rotation on the first lower axle 72 and a second lower wheel 78 is mounted for rotation on the second lower axle 74. It is preferred that both the first lower wheel 76 and the second lower wheel 78 have a concave outer surface 68 for engaging with the convex wheel receiving surface 46 of the lower portion 44 of the track 36.

Referring to both FIGS. 3 and 4, it can be appreciated that the upper tandem wheels 62, 64 and the lower wheel 66, or wheels 76, 78, of the present invention bound the track 36 between them. In other words, the upper and lower outer portions 40, 46 of the track 36 are located between the upper tandem wheels 62, 64 and the lower wheel 66, or wheels 76, 78, of the trolley 52. This design of the present invention permits the wheels 62, 64, 66 and/or 76, 78 of the trolley 52 grip the track 36 between them.

It is a further discovery of the present invention that the concave surfaces 68 of the wheels 62, 64, 66 or 76, 78 engage with the convex wheel receiving surfaces 42, 46 of the track 36 to prevent or eliminate lateral movement of the trolley 52 as it moves along the track 36.

Regardless of whether the wheel orientation of FIG. 3 is used or whether the wheel orientation of FIG. 4 is used, it can be appreciated that the upper wheels 62, 64 and the lower wheels 66 or 76, 78 are substantially in the same vertical plane 80 with one another in order to roll along the vertically aligned upper and lower portions 42, 46 of the track 36.

The wheels of either embodiment may be constructed of any material including, but not limited to, metal, such as stainless steel or an aluminum alloy, or polymers, such as plastic, nylon or rubber.

Referring back to FIG. 2, a plate 82 can be seen extending downwardly from the support rail 48 of the track 36. A gasket receiving portion 84 is located adjacent a lower portion 86 of the plate 82. Preferably, a gasket 88 is located in the gasket receiving portion 84. A portion 87A of the gasket 88 curves around the lower portion 86 of the plate 82 and extends in a substantially horizontal fashion toward the support plate 54 of the trolley 52. The gasket also comprises a portion 87B that curves inwardly toward the cargo portion 12. In the preferred embodiment, the gasket 88 contacts the support plate 54 and cargo portion 12 to prevent, or reduce, debris, contaminants and/or moisture from coming in contact with the portion of the trolley 52 facing the track 36. It can also be appreciated that only portion 87A or portion 87B can be used and not both. In the preferred embodiment, the gasket 88 runs the length of the cargo portion 12.

A tarp support 90, as seen in FIGS. 1, 2, 3 and 4, is located in a pocket 92 of the trolley 52. The tarp support 90 may be secured within the pocket 92 by mechanical type fasteners, clips, male/female couplings, welding and/or by providing the pocket 92 with dimensions slightly larger than the dimensions of the tarp support 90 to restrict any side-to-side movement of the tarp support 90 within the pocket 92.

Although a single tarp support 90 is shown extending from the trolley 52 in the figures, those skilled in the art will appreciate that two or more tarp supports 90 may extend from the trolley 52 without departing from the spirit or scope of the present invention. It is also within the scope of the present invention for a single tarp support 90 attached to the trolley 52 to branch into two or more supports above the trolley 52.

Referring back to FIG. 1, the tarp support 90 extends substantially vertically from the trolley 52. At a predetermined height, the tarp support 90 turns inwardly toward the cargo portion 12 of the trailer 10. The tarp support 90 extends across the cargo portion 12 of the trailer 10 in such a manner that the tarp support 90 is approximately horizontal with the cargo portion 12. The horizontal portion of the tarp support 90 may be a single structure, or it may branch into two or more beams to help support a tarp 94.

Adjacent the other track 36 on the second side 30 of the cargo portion 12, the tarp support 90 turns downwardly where it is connected to another trolley 52. Such tarp supports 90 are well known to those skilled in the art and may be such as those found in U.S. Pat. Nos. 5,538,313, 5,924,759, 6,065,796, and 6,634,697, which are incorporated by reference herein.

Preferably, a plurality of tarp supports 90, each connected to one or more trolleys 52, is utilized. A single, continuous tarp 94 is located over the plurality of tarp supports 90, as shown in FIG. 1. The tarp 94 may also comprise a plurality of individual tarps that are connected to one another or which are not connected to one another. The tarp, or tarps, are preferably secured to the tarp supports 90 by hook and loop type fasteners, clips, frictional fittings, male/female couplings, mechanical type fasteners, welding and/or by an adhesive.

FIG. 1 depicts one embodiment of the invention wherein a single, continuous tarp 94 covers an upper portion 96 and first and second side portions 98, 100 of the cargo portion 12. Those skilled in the art will readily appreciate that the present invention is in no way limited to this depicted embodiment and that the present invention may be used to selectively cover the upper portion 96, the first side portion 98 and/or the second side portion 100 of the cargo portion 12.

A method of using the present invention to at least partially, selectively cover the cargo portion 12 of a vehicle, such as a semi-trailer 10, comprises beginning with the above-mentioned plurality of tarp supports 90 and their associated trolleys 52 located adjacent the rear portion 20 or the forward portion 24 of the semi-trailer 10. The embodiment of the trolley 52 depicted in FIG. 3 will be used for the exemplary description of a method of using the present invention. Those skilled in the art will readily appreciate that the description also applies to the trolley depicted in FIG. 4.

With the tarp supports 90 and the trolleys 52 located adjacent the rear portion-20, the cargo portion 12 of the semi-trailer 10 is substantially fully exposed on both sides to facilitate loading, unloading and/or maneuvering cargo in the cargo portion 12.

Once the desired cargo is loaded, unloaded and/or maneuvered, a first tarp support 102 and associated trolleys 52 (one on each side of the trailer) are pulled by manual and/or automated means toward the forward portion 24, assuming they were initially located adjacent the rear portion 20, of the trailer 10. The tandem upper wheels 62, 64 and the lower wheel 66, or wheels, of the trolleys 52 on both sides 28, 30 of the cargo portion 12 rotate along their respective tracks 36. The concave surfaces 68 of the wheels 62, 64, 66 engage with the convex wheel receiving surfaces 42, 46 on the track 36 to reduce or eliminate lateral motion of the trolleys 52 and the tarp supports 90 as the wheels 62, 64, 66 roll along the track 36. More preferably, the tandem upper wheels 62, 64 roll on top of the wheel receiving surface 42 of the upper portion 40 and the lower wheel 66, or wheels, roll beneath the wheel receiving surface 46 of the lower portion 44.

It can be appreciated that since a tarp support 90 connects trolleys 52 on tracks 36 on the first side and the second side 28, 30 of the trailer 10, both trolleys 52 associated with the same tarp support 90 move forward down the tracks 36 at substantially the same rate and the same distance.

As the first tarp support 120 moves down the tracks 36, so does the tarp 94 attached to the first tarp support 120. The tarp 94, by virtue of being attached to each tarp support 90, removes the slack between the first tarp support 102 and at least the next adjacent tarp support 90 and its associated trolleys 52 and begins to pull this tarp support 90 and trolleys 52 down the tracks 36.

This process of moving the next adjacent tarp support 90 and trolleys 52, thus pulling the tarp 94 down the tracks 36, is used to position the first tarp support 102 and trolleys 52 adjacent the forward panel 26 of the trailer 10 and to locate the plurality of tarp supports 90 and trolleys 52 along the two tracks 36. When the first tarp support 102 and its associated trolleys 52 are located adjacent the forward panel 26, the plurality of other tarp supports 90 and associated trolleys 52 on each track 36 have positioned themselves substantially equidistant from one another. Thus, in this orientation, the tarp 94 carried by the tarp supports 90 is equally supported along the entire length of the cargo portion 12 of the trailer 10.

A locking means (not shown) is used to secure the first tarp support 102 to the forward panel 26 to ensure it does not undesirably retract toward the rear portion 20 of the trailer 10, particularly while the trailer 10 is attached to a tractor and moving down a road.

Based on the above, it can be appreciated that a tarp can be located over a vehicle using the above-described process and apparatus so as to inexpensively and easily selectively cover the vehicle while not appreciably extending the width of the vehicle.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A track and trolley system for a cargo portion of a vehicle, comprising:
a track secured to an outer surface of a cargo portion of a vehicle, said track having a single, outer, upper portion with a substantially convex wheel receiving surface and a single, outer, lower portion with a substantially convex wheel receiving surface that is substantially vertically aligned with said wheel receiving surface of said upper portion;
a trolley having a support plate with a first upper axle and at least a second upper axle, said first upper axle and said second upper axle comprising tandem axles, and at least one lower axle wherein each of said axles extend inwardly toward said track;
a wheel rotatingly attached to said first upper axle and a wheel rotatingly attached to said second upper axle wherein each of said wheels has a concave outer surface for engaging with and rotating on top of said convex wheel receiving surface of said upper portion;
a wheel rotatingly attached to said lower axle where said wheel has a concave outer surface for engaging with and rotating beneath said convex wheel receiving surface of said lower portion and wherein said wheels on said upper axles and said wheel on said lower axle bound said track between them; and
a gasket securing portion attached to said track for securing a portion of a gasket therein wherein said gasket extends substantially horizontally so that a second end of said gasket contacts said support plate.

2. The system of claim 1, wherein a tarp support is attached to said support plate of said trolley for supporting a tarp over said cargo portion.

3. The system of claim 1, wherein said substantially convex wheel receiving surfaces of said track are V-shaped.

4. The system of claim 1, wherein said substantially concave outer surfaces of said wheels are V-shaped.

5. The system of claim 1, wherein a substantially continuous, hollow channel is located between said upper portion of said track and said lower portion of said track.

6. The system of claim 1, wherein said upper portion of said track and said lower portion of said track are integrally formed with one another.

7. The system of claim 1, wherein said wheel attached to said lower axle is located substantially mid-way between said wheel on said first upper axle and said wheel on said second upper axle, said wheel attached to said lower axle being horizontally aligned with, but vertically offset from, said upper wheels.

8. The system of claim 1, wherein said wheel mounted on said first upper axle is horizontally aligned with said wheel mounted on said second upper axle.

9. The system of claim 1, wherein said support plate has a substantially vertical upper portion and a lower substantially horizontal portion.

10. The system of claim 1, wherein said cargo portion of said vehicle is a semi-trailer.

11. A track and trolley system for a vehicle trailer, comprising:
a track secured to a vehicle trailer, said track having a single, outer, upper portion with a V-shaped wheel receiving surface and a single, outer, lower portion with a V-shaped wheel receiving surface aligned with said wheel receiving surface of said upper portion;
a trolley having a support plate for rotatingly mounting upper tandem wheels and at least a single lower wheel thereon, wherein each of said upper wheels has a V-shaped outer surface for rotating on top of said V-shaped wheel receiving surface of said upper portion, and wherein said lower wheel has a V-shaped outer surface for rotating beneath said V-shaped wheel receiving surface of said lower portion, and wherein said upper wheels said lower wheel bound said track between them.

12. The system of claim 11, further comprising a gasket secured to said track to reduce debris from entering said track.

13. The system of claim 11, wherein a tarp support is attached to said support plate of said trolley for supporting a tarp over said vehicle trailer.

14. The system of claim 11, wherein a substantially continuous, hollow channel is located between said upper portion of said track and said lower portion of said track.

15. The system of claim 11, wherein said lower wheel is located substantially mid-way between said upper tandem wheels and said lower wheel is horizontally aligned with, but vertically offset from, said tandem upper wheels where said tandem upper wheels are horizontally aligned with one another.

16. A method of using a tarp system for a vehicle, comprising:
selectively moving a tarp over a vehicle via a plurality of moveable trolleys, wherein each of said trolleys has at least one tarp support attached thereto for supporting said tarp;
said tarp being moved over said vehicle by rotating a first wheel in an upper tandem wheel set on each of said trolleys along a track attached to said vehicle, said first wheel having a concave outer surface for rolling on top of a convex wheel receiving surface located on an upper, outer portion of said track and rotating a second wheel in said tandem wheel set on top of said same convex wheel receiving surface, said second wheel also having a concave outer surface; and
said tarp being moved over said vehicle also by rotating at least one lower wheel of said trolley along said track, said lower wheel located below said upper tandem wheel set and substantially in the same horizontal plane as said tandem wheel set, said lower wheel having a concave outer surface for rolling beneath a convex wheel receiving surface of a lower, outer portion of said track, said lower wheel and said tandem wheel set bounding said track between them.

17. The method of claim 16, further comprising locating a gasket in said track to protect at least said track from debris.

18. The method of claim 16, wherein said concave outer surfaces of said upper and lower wheels engage with said convex outer surfaces of said track to reduce lateral movement of said trolley along said track.

19. The method of claim 16, wherein a semi-trailer is used as said vehicle.
